(19) United States
(12) Patent Application Publication
(10) Pub. No.: US 2026/0116102 A1
(43) Pub. Date: Apr. 30, 2026

(54) IMAGE FORMING APPARATUS

(71) Applicant: CANON KABUSHIKI KAISHA, Tokyo (JP)

(72) Inventor: TOMOKI MUKAI, Ibaraki (JP)

(21) Appl. No.: 19/371,836

(22) Filed: Oct. 28, 2025

(30) Foreign Application Priority Data
Oct. 31, 2024 (JP) 2024-192527

(51) Int. Cl. B41J 13/14; B41J 11/06; B41J 13/08

(52) U.S. Cl. CPC B41J 13/14; B41J 11/06; B41J 13/08

(57) ABSTRACT

An image forming apparatus includes a rotatable endless belt; a recording head; a platen member; a first guiding member provided movably in a direction crossing the conveying surface and for guiding a first surface, of the sheet conveyed toward the conveying surface, opposing the recording head; a second guiding member for guiding a second surface of the sheet conveyed toward the conveying surface; a first supporting portion provided movably and integrally with the first guiding member and for supporting the first guiding member in contact with the conveying surface; and a second supporting portion provided between the first guiding member and the second guiding member and for supporting the first guiding member relative to the second guiding member.

### BACKGROUND

### Field of the Technology

The present disclosure relates to an image forming apparatus, such as a printing machine, a copying machine, or a printer, for performing image formation by utilizing an ink jet type.

### Description of the Related Art

In recent years, also, in the field of commercial printing and industrial printing in which analog printing such as offset printing goes mainstream, there is an increasing need for ink jet printing as digital printing capable of printing of designs in small amount and many kinds. The ink jet type has many advantages that a printing plate is not required and that a high-quality product can be obtained, and the like, and therefore, spread thereof is conspicuous. The image forming apparatus of the ink jet type (ink jet recording apparatus) ejects ink droplets on a recording medium (sheet) such as recording paper or a resin sheet and records an image such as a character. As the image forming apparatus of the ink jet type, there is an ink jet recording apparatus of a line head type. In this recording apparatus, in a state in which a recording head is not moved relative to an image forming apparatus main assembly, in association with conveyance of the recording medium, liquid droplets of different colors are ejected from a plurality of recording heads, so that a color image is recorded on the recording medium. Further, as the ink jet recording apparatus of the line head, a recording apparatus in which conveyance of the recording medium relative to the recording heads is performed by using a print belt constituted by an endless belt has been known. The print belt is stretched by a plurality of stretching rollers, and the recording medium is attracted to a conveying surface which is a surface formed between the stretching rollers on sides upstream and downstream of the recording heads and is conveyed.

In such an image forming apparatus, in order to obtain a high-quality product, a distance between the recording medium and the recording head (specifically, minute nozzles ejecting ink of the recording head) (herein, this distance is also referred to as a "print gap") is important. For that reason, a type in which a cut recording medium is conveyed along a flat surface (printing flat surface) high in flatness has been known. As one example of such a type, there is a method in which the recording medium is conveyed while being sucked to a conveying surface of a print belt (Japanese Laid-Open Patent Application No. 2016-140997). That is, the print belt is provided with minute holes, and in addition, the print belt is slidably supported by a platen member constituted so as to have an opening. Then, air is sucked from an inner peripheral surface side of the print belt, so that the print belt is attracted to the platen member, and in addition, the recording medium is conveyed by the print belt while being attracted to the print belt.

In the ink jet recording apparatus, a difference is guided in image quality due to a variation in print gap. For example, due to a thickness of the recording medium or the like, the print gap is lost, i.e., when the recording medium and the recording head are in contact with each other, it leads to not only a lowering in quality of a product but also breakage of the recording head in some instances.

For that reason, it is desired that the print gap is not changed by exceeding a tolerable amount.

As a means therefor, it would be considered that a platen member is raised and lowered so that the print gap is maintained at a substantially constant level depending on the thickness of the recording medium.

However, in the case where a constitution in which the platen member is raised and lowered is employed, when a guiding member for guiding the recording medium is fixed to the conveying surface of the print belt, there is a liability that conveyance of the recording material becomes unstable in the case where, for example, a distance between the print belt and the guiding member becomes narrow.

### SUMMARY

The present disclosure is directed to enable that conveyance of a sheet to a conveying surface of a print belt is stably performed even when the conveying surface of the print belt is raised and lowered with raising and lowering of a platen member.

This is achieved by an image forming apparatus according to the present disclosure.

According to an aspect of the present invention, there is provided an image forming apparatus comprising: a rotatable endless belt configured to carry and convey a sheet; a recording head provided opposed to the belt and configured to eject a liquid for recording to the sheet conveyed by the belt; a platen member provided in a position opposing the recording head through the belt and configured to support an inner peripheral surface of the belt and to form a conveying surface on which the sheet is conveyed, the platen member being supported movably in a thickness direction of the belt; a first guiding member provided movably in a direction crossing the conveying surface and configured to guide a first surface, of the sheet conveyed toward the conveying surface, opposing the recording head; a second guiding member configured to guide a second surface of the sheet conveyed toward the conveying surface; a first supporting portion provided movably and integrally with the first guiding member and configured to support the first guiding member in contact with the conveying surface; and a second supporting portion provided between the first guiding member and the second guiding member and configured to support the first guiding member relative to the second guiding member.

Features of the present disclosure will become apparent from the following description of embodiments with reference to the attached drawings. The following description of embodiments are described by way of example.

### BRIEF DESCRIPTION OF THE DRAWINGS

FIG. 1 is a schematic sectional view of the image forming apparatus.

FIG. 2 is a schematic sectional view of a print module.

FIG. 3 is a perspective view of a print belt unit.

FIG. 4 is a perspective view of a suction box.

FIG. 5 is a perspective view of a print gap adjusting mechanism.

FIG. 6 is a perspective view of guiding members and a belt-guide gap adjusting mechanism.

FIG. 7 is a schematic sectional view of the guiding members and the belt-guide gap adjusting mechanism.

FIG. 8 is a schematic view of the guiding members viewed along a conveying direction of a sheet.

FIG. 9 is a schematic view for illustrating another operation of the guiding members.

### DESCRIPTION OF THE EMBODIMENTS

In the following, an image forming apparatus according to the present disclosure will be described further specifically with reference to the drawings.

### Embodiment 1

### Image forming apparatus

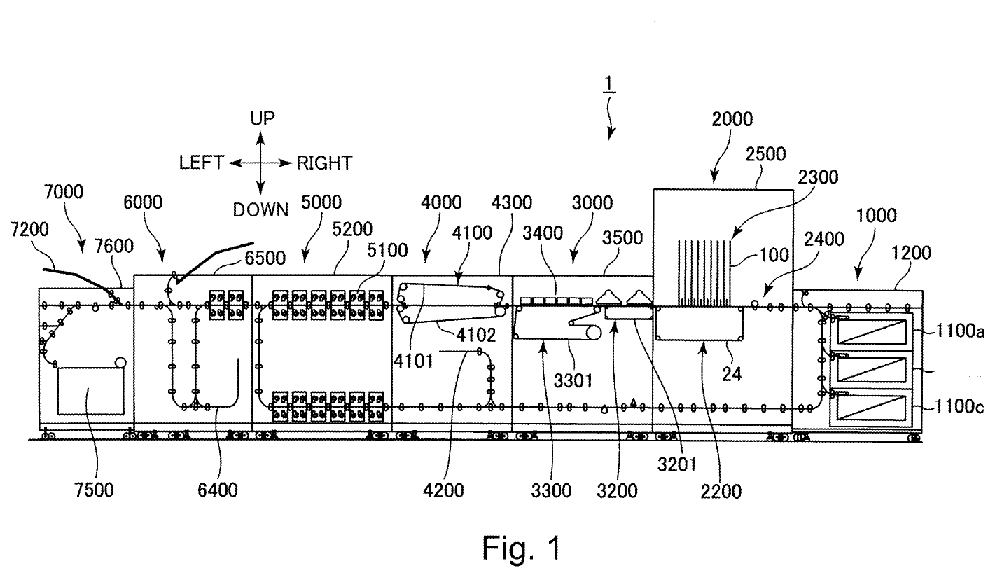

First, a general constitution of an image forming apparatus according to this embodiment will be described. The image forming apparatus of this embodiment is an ink jet recording apparatus 1 of a line head type utilizing an ink jet type. FIG. 1 is a schematic sectional view showing a general constitution of the ink jet recording apparatus 1 of this embodiment. This ink jet recording apparatus 1 is a sheet type ink jet recording apparatus in which an ink image is formed on a sheet S such as out plain paper, which is a recording medium (recording material, sheet) by using two liquids, as liquids for recording, consisting of a reaction liquid and ink and then a recording product is outputted.

Incidentally, in the following description, the ink jet recording apparatus 1 is assumed to be installed on a horizontal surface. Further, as regards the ink jet recording apparatus 1 and elements thereof, on the drawing sheet of FIG. 1, a front side is referred to as a "front (front surface)" side, a rear side is referred to as a "rear (rear surface)" side, a right side is referred to as a "right" side, a left side is referred to as a "left" side, an upper side is referred to as an "upper (UP)" side, and a lower side is referred to as a "lower (DOWN)" side. A front-rear direction is perpendicular to a left-right direction and an up-down direction. In the case where the ink jet recording apparatus 1 is installed on the horizontal surface, the up-down direction is parallel to a gravitational direction (vertical direction). However, as regards the ink jet recording apparatus 1 and the elements thereof, the "up" and the "down" do not mean only "immediately above", and "immediately below", respectively, and include an "upper side" and a "lower side", respectively, with respect to a horizontal surface passing through a noticed element or a noticed position.

Further, in the following description, the sheet S is referred to as paper, but the sheet S includes a material other than paper, or those (synthetic paper and film formed using synthetic resin, metalized paper having a metal layer, and the like) formed of a material containing the material other than the paper. Further, for convenience, the liquid for recording, such as the reaction liquid or the ink is simply referred to as "ink", but may also be an arbitrary liquid, such as a reaction liquid or ink, used for image recording.

The ink jet recording apparatus 1 includes modules (sheet processing portion) including a sheet (paper) feeding module 1000, a print module 2000, a drying module 3000, a fixing module 4000, a cooling module 5000, a reversing module 6000, and a sheet (paper) discharge stacking module 7000. A cut paper-like sheet S fed from the sheet feeding module 1000 is conveyed along a conveying path and processed by the respective modules, and then is guided to the sheet discharge stacking module 7000.

The sheet feeding module 1000 includes three accommodating boxes 1100a, 1100b, and 1100c for accommodating sheets S, and a casing 1200 in which these boxes are accommodated, and the like member. Each of the accommodating boxes 1100a, 1100b, and 1100c is constituted so as to be capable of being pulled out toward a front side relative to the casing 1200. The sheets S are fed from each of the accommodating boxes 1100a, 1100b, and 1100c one by one by a separation belt and conveying rollers, and the fed sheet S is conveyed toward the print module 2000. Incidentally, the number of the accommodating boxes 1100a, 1100b, and 1100c is not limited to three, but may also be one, two, or four or more.

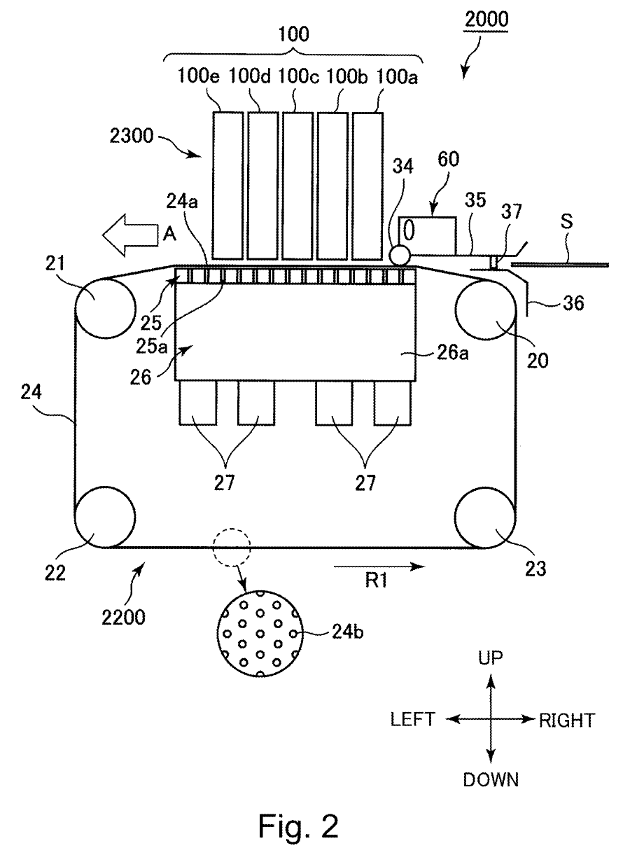

The print module 2000 includes a registration correcting portion (pre-image formation registration correcting portion) 2400, a print belt unit 2200 as a belt conveying device, a recording portion (image forming portion) 2300, a casing 2500 for accommodating therein these members, and the like. The sheet S conveyed from the sheet feeding module 1000 to the print module 2000 is corrected in inclination and position thereof by the registration correcting portion 2400 and is conveyed toward the print belt unit 2200. The recording portion 2300 is disposed in a position opposing the print belt unit 2200 while sandwiching a conveying path of the sheet S therebetween. The recording portion 2300 form an image on the sheet S by subjecting the sheet S, conveyed by the print belt unit 2200, to recording processing (image formation, printing, print) from above by a recording head 100. The sheet S is ensured to form a clearance between itself and the recording head 100 by being attracted and conveyed by a print belt 24 of the print belt unit 2200. A conveying direction of the sheet S by the print belt unit 2200 is a direction from a left side toward a right side. Further, the recording portion 2300 includes a plurality of recording heads (line type recording heads) 100 arranged along the conveying direction of the sheet S. In this embodiment, the recording portion 2300 includes five recording heads 100 (100a to 100e), as the plurality of recording heads 100, corresponding to four colors of Y (yellow), M (magenta), C (cyan), and Bk (black), and a reaction liquid (FIG. 2). Incidentally, the number of the colors and the number of the recording heads 100 are not limited to five. As the ink jet type of the recording heads 100, it is possible to employ a type using heat generating elements, a type using piezoelectric elements, a type using electrostatic elements, a type using MEMS elements, and the like type. Each of the color inks is supplied from an ink tank provided to the print module 2000 to the corresponding recording head 100 through an ink tube, for example. The sheet S subjected to recording processing by the recording portion 2300 is conveyed by the print belt unit 2200 and passes through an in-line scanner (not shown) provided on a side downstream of the recording portion 2300 with respect to the conveying direction of the sheet S. The ink jet recording apparatus 1 is capable of correcting a print image on the basis of deviation and color density of the image formed on the sheet S, detected by the in-line scanner.

The drying module 3000 includes a decoupling portion 3200, a drying belt unit 3300, a warm air blowing portion 3400, a casing 3500 accommodating these members therein, and the like. The drying module 3000 reduces a liquid component contained in the ink supplied onto the sheet S in the recording portion 2300 and enhances a fixing property between the sheet S and the ink. The sheet S subjected to the recording processing by the recording portion 2300 of the print module 2000 is conveyed to the decoupling portion 3200 disposed in the drying module 3000. The decoupling portion 3200 is capable of conveying the sheet S by air pressure from above and friction of the decoupling portion 3200 with a belt 3201. In the decoupling portion 3200, the sheet S on the belt 3201 is conveyed while being weakly held, so that deviation of the sheet S, on which an ink image is formed, on the print belt 24 of the print belt unit 2200 can be prevented. The sheet S conveyed from the decoupling portion 3200 to the drying belt unit 3300 is sucked and conveyed by a belt 3301 of the drying belt unit 3300. Simultaneously therewith, hot air is supplied from the warm air blowing portion 3400 disposed above the belt 3301 of the drying belt unit 3300, so that the surface of the sheet S on which the ink is supplied is dried. Incidentally, as a drying type, it is possible to use, in addition to the type of supplying the hot air, a type irradiating the surface of the sheet S with electromagnetic radiation (such as ultraviolet radiation or infrared radiation) and a conductive heat transfer type by contact of a heat generating member. These types may be combined arbitrary.

The fixing module 4000 includes a fixing belt unit 4100 and a casing 4300 accommodating the fixing belt unit 4100. The fixing module 4000 is capable of fixing the ink on the sheet S by passing the sheet S, conveyed from the drying module 3000 to the fixing module 4000, through between an upper belt unit 4101 and a lower belt unit 4102 which are heated.

The cooling module 5000 includes a plurality of cooling portions 5100 and a casing 5200 accommodating these cooling portions 5100. The cooling module 5000 cools the sheet S conveyed from the fixing module 4000 to the cooling module 5000 and high in temperature. The cooling portion 5100 takes external air into a cooling box and increases pressure in the cooling box, and is constituted so as to cool the sheet S by blowing wind, jetted from nozzles formed on a conveying guide. The cooling portion 5100 is disposed on each of opposite sides while sandwiching a conveying path of the sheet S, and is capable of cooling the sheet S from the opposite sides. Further, in the cooling module 5000, a switching portion for switching the conveying path of the sheet S is provided. This switching portion is capable of switching the conveying path of the sheet S depending on the case where the sheet S is conveyed to the reversing module 6000 and the case where the sheet S is conveyed to a double-side conveying path used during double-side printing. During the double-side printing, the sheet S is conveyed to the double-side conveying path provided in a lower portion of the cooling module 5000 and is further conveyed along the double-side conveying path provided in lower portion of the fixing module 4000, the drying module 3000, the print module 2000, and the sheet feeding module 1000. By this, the sheet S is convey again toward the registration correcting portion 2400 of the print module 2000, the print belt unit 2200, and the recording portion 2300, and is subjected to the recording processing by the recording portion 2300. Incidentally, the double-side conveying path of the fixing module 4000 is provided with a first reversing portion 4200 for turning the sheet S upside down, and the first reversing portion 4200 is configured so as to be capable of conveying the sheet S again toward the recording portion 2300 after the sheet S is turned upside down during the double-side printing.

The reversing module 6000 includes a second reversing portion 6400, a casing 6500 accommodating this second reversing portion 6400, and the like. The reversing module 6000 is capable of turning the sheet S, conveyed from the cooling module 5000 to the reversing module 6000, upside down and is capable of freely changing front/rear surfaces (sides) of and a direction of leading/trailing ends, with respect to the conveying direction, of the sheet S to be discharged from the reversing module 6000.

The sheet discharge stacking module 7000 includes a top tray 7200, a stacking portion 7500, a casing 7600 provided with these portions 7200 and 7500, and the like. The sheet discharge stacking module 7000 is capable of aligning sheets conveyed from the reversing module 6000 to the sheet discharge stacking module 7000 and then discharging and stacking the sheets onto the top tray 7200 or stacking and accommodating the sheets S into the stacking portion 7500.

### Print belt unit

Next, the print belt unit 2200 in this embodiment will be described. FIG. 2 is a schematic sectional view of the print module 2000 provided with the print belt unit 2200 in this embodiment.

The print belt unit 2200 includes a plurality of stretching rollers 20 to 23, the print belt 24, a suction box (vacuum box, platen unit) 26, and a negative pressure guiding unit (suction device) 27.

The rotatable print belt (conveying belt) 24 constituted by an endless belt is extended around, as a plurality of stretching rollers, four stretching rollers consisting of first, second, third, and fourth stretching rollers 20, 21, 22, and 23, respectively, and is stretched with predetermined tension. In this embodiment, the print belt 24 is constituted by using, for example, PET (polyethylene terephthalate) which is a resin material. Further, in this embodiment, a size of the print belt 24 with respect to a widthwise direction (direction substantially perpendicular to a surface movement direction) is set so that a sheet S having, for example, a B3 size (364mm x 515mm) can be fed laterally (conveyed so that a short side extends in a direction along the conveying direction). Incidentally, the resin material constituting the print belt 24 is not limited to PET, but it is possible to use, for example, other resin materials such as polyimide and polycarbonate, and a metal material.

Of a surface of the print belt 24 formed by the first to fourth stretching rollers 20 to 23, on a conveying surface 24a which is an outer peripheral surface of the print belt 24 stretched between the first stretching roller 20 and the second stretching roller 21, the sheet S is carried and conveyed. The first stretching roller 20 and the second stretching roller 21 function as conveying surface forming rollers for forming the conveying surface 24a of the print belt 24.

Further, the second stretching roller 21 functions as driving roller for rotating (circulating and moving) the print belt 24 in an arrow R1 direction (counterclockwise direction). Further, the third stretching roller 22 functions as a tension roller urged from the inner peripheral surface side toward an outer peripheral surface side of the print belt 24 by an urging mechanism (not shown) as an urging means and for applying a force, to the print belt 24, for stretching the print belt 24. Further, the fourth stretching roller 23 functions as a steering roller of which one end portion with respect to a rotational axis direction is movable and of which rotational axis direction is tiltable so as to be inclined relative to rotational axes of other stretching rollers. The second stretching roller 21 is rotationally driven by a driving force transmitted from a motor which is a driving source provided in a belt driving portion (not shown) as a driving means provided in the print belt unit 2200. The first, third, and fourth stretching rollers 20, 22, and 23 are rotated with rotation of the print belt 24. The plurality of stretching rollers 20 to 23 are rotatably supported by supporting side plates (not shown) constituting the print belt unit 2200 in opposite end portions thereof with respect to the rotational axis directions thereof. The supporting side plates are mounted to a belt unit frame (not shown) which is a supporting structure constituting the print belt unit 2200. Incidentally, the number of the stretching rollers for the print belt 24 is not limited to four, but may also be two, three or more than four.

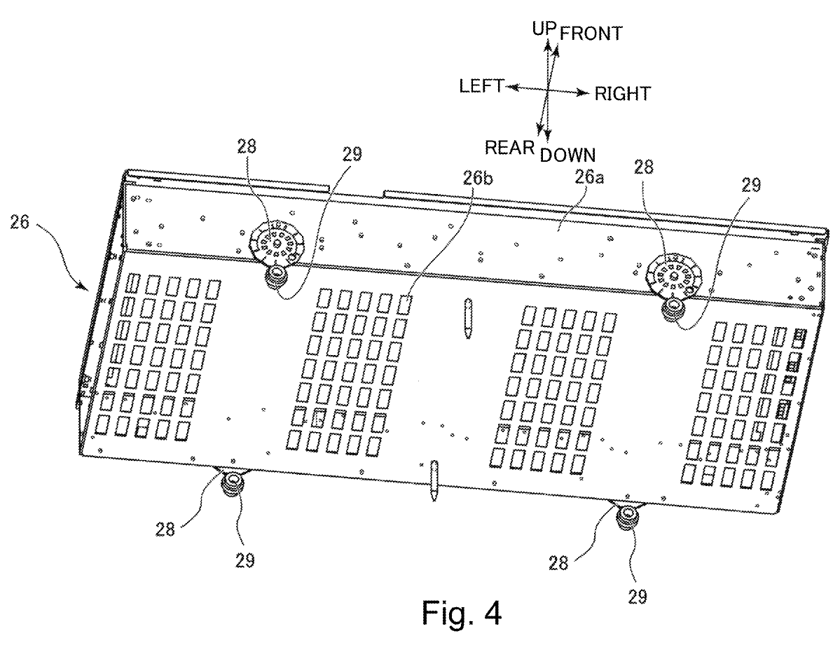

The print belt unit 2200 conveys the sheet S in an arrow A direction by rotation of the print belt 24 stretched by the plurality of stretching rollers 20 to 23. The print belt 24 is provided with a plurality of suction holes (through holes) 24b each of about 0.3 mm in diameter over a full circumference in order to suck and convey the sheet S. With respect to a direction substantially perpendicular to the conveying direction A of the sheet S, the suction box 26 is provided on a side opposite from the recording portion 2300 through the print belt 24. The suction box 26 is constituted by including a platen member 25 and a suction box frame 26a as a holding member forming the suction box 26 by holding the platen member 25. In this embodiment, the suction box 26 has a predetermined length in each of a longitudinal direction along a left-right direction and a widthwise direction along a front-rear direction and has a predetermined height in an up-down direction, so that the suction box 26 is formed in a box shape as a whole. The suction box 26 (specifically, the platen member 25) is disposed so as to be contactable to the print belt 24 at least in a range including an entire region from a position opposing a most upstream recording head 100a (specifically, nozzle thereof) to a position opposing a most downstream recording head 100e (specifically, nozzle thereof) with respect to a movement direction (left-right direction, traveling direction) of the conveying surface 24a of the print belt 24. Further, in this embodiment, the suction box 26 is disposed so as to be contactable to the print belt 24 at least in a range including a substantially entire area of a region, with respect to the widthwise direction (front-rear direction) of the print belt 24 is capable of being carried. The platen member 25 is provided so as to form an position-side surface of the suction box 26 and forms a sliding surface slidably supporting the print belt 24. The platen member 25 is provided with a plurality of suction openings (through holes) 25a. Further, exhaust openings (through holes) 26b (FIG. 4) are provided in a lower-side surface (bottom) of the suction box frame 26a. To the exhaust openings 26b, a negative pressure generating unit 27 as a negative pressure generating means (suction means) for generating negative pressure in the suction box 26 is connected.

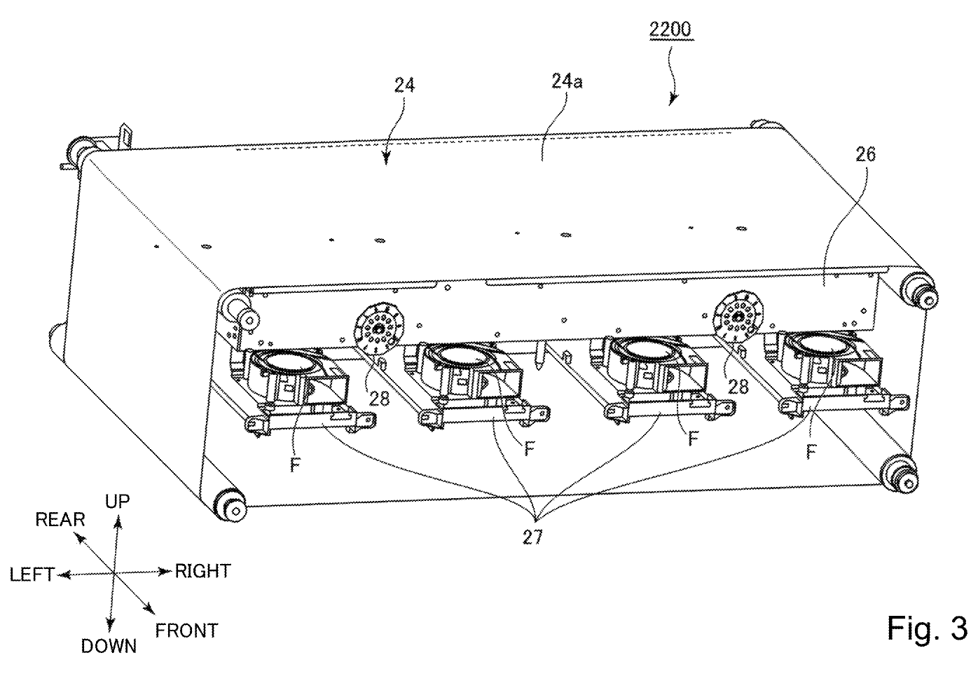

FIG. 3 is a perspective view of the print belt unit 2200 in this embodiment, in which the suction box 26 and the negative pressure generating unit 27 are shown. The negative pressure generating unit 27 is provided with a fan F. The negative pressure generating unit 27 generates negative pressure in the suction box 26 by discharging air inside the suction box 26. By the negative pressure generated by the negative pressure generating unit 27, the pressure of the inside of the suction box 26 becomes substantially constant. By this, the print belt 24 on the platen member 25 is attracted onto the platen member 25 by being sucked through the plurality of suction openings 25a of the platen member 25. Further, the negative pressure in the suction box 26 generates a suction force in a plurality of suction holes 24b provided in the print belt 24, so that the sheet S is attracted to the print belt 24. Incidentally, a suction force generating source of the negative pressure generating unit 27 is not limited to the fan, but may also be a vacuum pump, for example.

Thus, the print belt 24 carries and conveys the sheet S on the conveying surface 24a opposing the recording head 100 immediately below the recording head 100. On the inner peripheral surface side of the print belt 24, the suction box 26 as the belt supporting portion slidably supporting the print belt 24 while sucking the print belt 24. The suction box 26 slidably supports the inner peripheral surface of the print belt 24 between the first stretching roller 20 and the second stretching roller 21 with respect to a rotational direction (traveling direction) of the print belt 24, i.e., an inner peripheral surface of the print belt 24 corresponding to the conveying surface 24a.

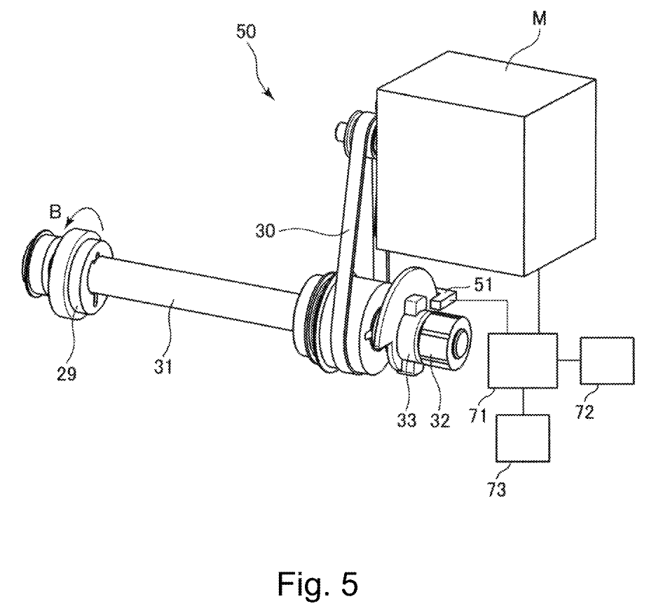

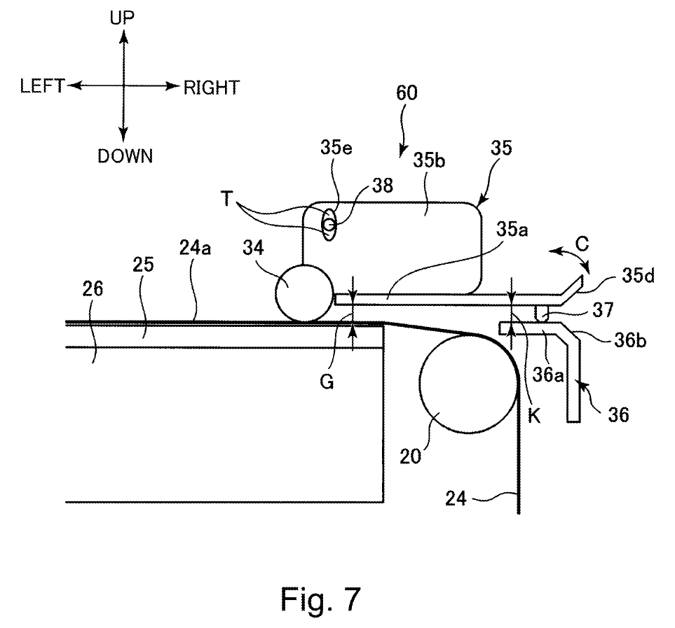

Further, the print belt unit 2200 is provided with an upper guide 35 and a lower guide 36 which are as a guiding member for guiding the sheet S to the conveying surface 24a of the print belt 24 (FIG. 2). Further, the print belt unit 2200 is provided with a print gap adjusting mechanism 50 for adjusting a print gap (FIGS. 4 and 5). Further, the print belt unit 2200 is provided with a belt-guide gap adjusting mechanism 60 for adjusting a distance between the conveying surface 24a of the print belt 24 and the upper guide 35 (herein, this distance is also referred to as a "belt-guide gap (gap between the belt and the guide)" (FIG. 7). These members (upper guide 35, lower guide 36), print gap adjusting mechanism 50, and belt-guide gap adjusting mechanism 60 will be described later.

### Print gap adjusting mechanism

In the ink jet recording apparatus, a difference in image quality occurs due to a variation print gap which is a clearance between the recording head and the sheet. For example, due to a thickness of the sheet or the like, the print gap is lost, i.e., when the sheet and the recording head is in contact with each other, it leads to not only a lowering in quality of a product but also breakage of the recording head in some instances.

For this reason, it is desired that the print gap is not changed by exceeding a tolerable amount.

As a means therefor, it is effective that the platen member is raised and lowered so that the print gap is maintained to a substantially constant distance depending on the thickness of the sheet. For example, a constitution in which the platen member is raised and lowered by a cam by rotating the cam to a predetermined phase (position with respect to a rotational direction) by an amount depending on the thickness of the sheet by using a driving means and thus in which the print gap is adjusted is employed.

In the ink jet recording apparatus 1, a position of the recording portion 2300 provided with the recording heads 100 is fixed by a belt unit frame (not shown) which is an immovable part other than the suction box 26, and a position of the suction box 26 is made variable. Further, the ink jet recording apparatus 1 of this embodiment is constituted so that when the sheet S on which the image is formed is changed to a sheet S different in thickness, the platen member 25 is moved by moving the suction box 26 and thus the print gap is adjusted. Further, as described later specifically, in this embodiment, the ink jet recording apparatus 1 includes the print gap adjusting mechanism for adjusting the print gap by changing a height of the suction box 26 thickness rotation of the cam.

FIG. 4 is a perspective view of a constitution of a part of the print belt unit 2200 in this embodiment, in which the suction box 26 and cams 29 constituting the print gap adjusting mechanism 50 are shown. Further, FIG. 5 is a schematic perspective view of the print gap adjusting mechanism 50 in this embodiment.

As shown in FIG. 4, the suction box 26 contacts the cams 29 in pressing portions 28 which are provided substantially in four corners thereof. As shown in FIG. 5, a driving force is transmitted from a stepping motor M as a driving source toward a shaft 31, to which the cam 29 as an acting portion is mounted, by a driving belt 30 as a drive transmitting member, so that the cam 29 is rotated. When a rotational direction of the stepping motor M is changed, there is a possibility that a rotation angle and a height of an uppermost point of the cam 29 are not uniquely determined due to backlash with respect to a circumferential direction generated on the basis of a dimension tolerance of each of parts. For that reason, in this embodiment, the stepping motor M is controlled so that the cam 29 is rotated only in one direction which is an arrow B direction in FIG. 4.

The cam 29 receives a force from the pressing portion 28 toward the cam 29 by a self-weight of the suction box 26 and tension of the stretched print belt 24. By this, the force is exerted on the cam 29 in a direction opposite to the rotational direction B. For that reason, in this embodiment, one-way clutch 32 is disposed on the shaft 31 so that rotation of the cams 29 in the direction opposite to the rotational direction B is restricted by a frame (not shown) of the print belt unit 2200. By this, during a printing operation, it is possible to prevent that the height of the suction box 26 is changed due to rotation of the cams 29 in the direction opposite to the rotational direction B by the force in the direction opposite to the rotational direction B. Further, in this embodiment, by the one-way clutch 32, a fluctuation in height of the suction box 26 by the rotation of the cams 29 in the direction opposite to the rotational direction B is prevented, and therefore, in a period other than during adjustment of the print gap, electric power supply to the stepping motor M is not performed. On the shaft 31, a sensor flag 33 is provided, so that a reference of the rotation angle of the cam 29 is capable of being detected by a phase detecting sensor 51. The phase detecting sensor 51 is constituted by an optical sensor.

In this embodiment, the print gap adjusting mechanism 50 is constituted by the cams 29, the stepping motor M, the driving belt 30, the shaft 31, the one-way clutch 32, the sensor flag 33, and the phase detecting sensor 51, and the like.

In this embodiment, during assembling of the print belt unit 2200, in a stage in which the print gap adjusting mechanism 50 is mounted, a rotation angle of the cam 29 when an uppermost point of the cam 29 (or the suction box 26 or the conveying surface 24a) becomes a desired height is required. Then, information indicating a relationship between the height and the rotation angle is stored in a ROM 72, which is a storage device, provided in the print belt unit 2200. At this time, the rotation angle stored in the ROM 72 is caused to correspond to the number of rotation steps of the stepping motor from a reference detected by the sensor flag 33. Further, this rotation angle can be stored in a plurality of numbers in the ROM 72 depending on a kind of the desired height. By storing the above-descried information in the ROM 72 during the assembling of the print belt unit 2200, it is possible to suppress a variation in height due to tolerance of parts. For that reason, even when a plurality of print gap adjusting mechanisms 50 (in this embodiment, four) are used, precise print gap adjustment suppressed in variation becomes possible.

### Problem

As described above, in the case where the constitution in which the platen member 25 is raised and lowered is employed, when the guiding members for guiding the sheet S to the conveying surface 24a of the print belt 24 is fixed, the distance between the print belt 24 and the guiding members is increased and decreased depending on raising and lowering of the platen member 25. A conveyance resistance force of the sheet S received from the guiding members is increased when the distance between the print belt 24 and the guiding members becomes narrow. For that reason, for example, in the case where the distance between the print belt 24 and the guiding members is narrowed by raising and lowering the platen member 25, there is a liability that conveyance of the sheet S becomes unstable.

Therefore, in this embodiment, even when the platen member 25 is raised and lowered, the distance between the print belt 24 and the guiding members can be made enable to maintain a substantially constant level at a desired distance, so that the convey of the sheet S to the conveying surface 24a of the print belt 24 is made enable.

### Belt-guide gap adjusting mechanism

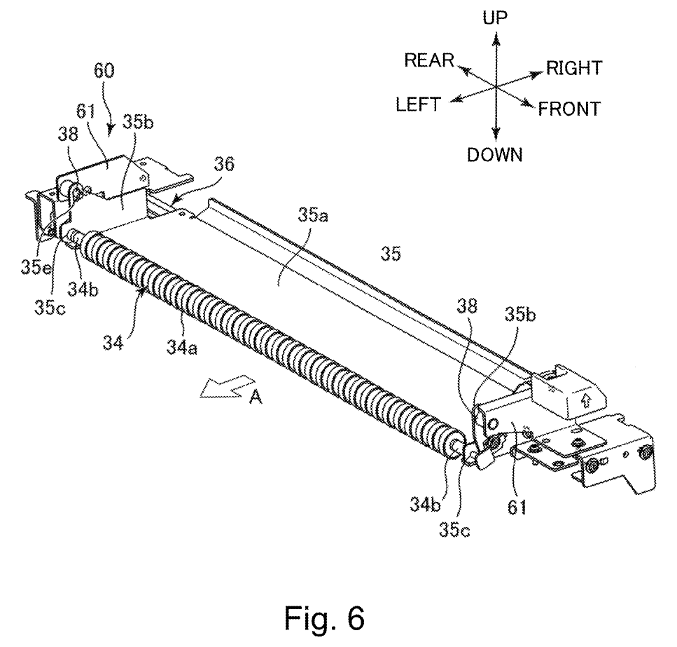

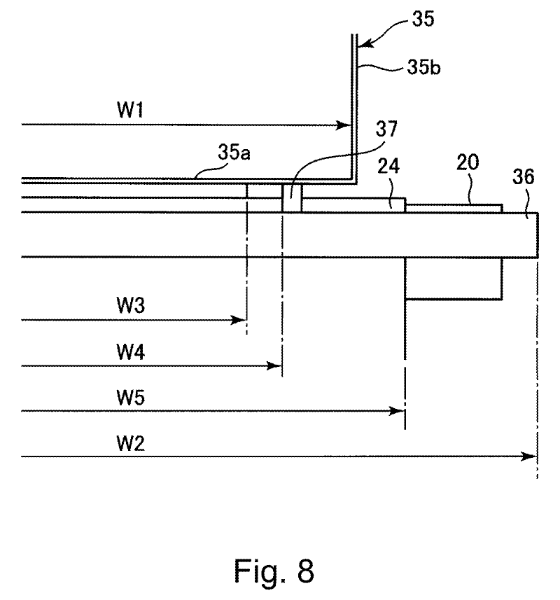

Next, the guiding members (upper guide 35, lower guide 36) and the belt-guide gap adjusting mechanism 60 in this embodiment will be described. FIG. 6 is a perspective view showing the guiding members (upper guide 35, lower guide 36) and the belt-guide gap adjusting mechanism 60 in this embodiment. Further, FIG. 7 is a schematic sectional view of a constitution of a part of the print belt unit 2200, in which the guiding members (upper guide 35, lower guide 36) and the belt-guide gap adjusting mechanism 60 as shown. FIG. 8 is a schematic view (showing only one end portion side of the print belt 24 with respect to the widthwise direction) of the guiding members (upper guide 35, lower guide 36) in this embodiment as viewed along the conveying direction of the sheet S.

As shown in FIGS. 6 and 7, the print belt unit 2200 is provided with the upper guide (first guiding member) 35 and the lower guide (second guiding member) 36 which are as guiding members for guiding the sheet S to the conveying surface 24a of the print belt 24.

The upper guide 35 includes a flat plate-like upper guiding portion 35a having a predetermined width with respect to the left-right direction (conveying direction of the sheet S) and extending in the front-rear direction (widthwise direction of the print belt 24) and includes holding portions 35b and 35b extending upward from the upper guiding portion 35a in opposite end portions with respect to the front-rear direction. The upper guiding portion 35a is disposed on a surface side (upper side) where the sheet S is subjected to recording processing by the recording portion 2300 immediately after passing through the guiding members (upper guide 35, lower guide 36). In this embodiment, the upper guiding portion 35a and the holding portion 35b and 35b are integrally formed by a plate-like member (metal plate) made of metal. At least a part of an end portion side of a left side (downstream side with respect to the conveying direction of the sheet S) of the upper guiding portion 35a with respect to the left-right direction opposes the conveying surface 24a of the print belt 24 formed by the suction box 26 (overlaps with the conveying surface 24a with respect to the left-right direction). At least a part of an end portion side of a right side (upstream side with respect to the conveying direction of the sheet S) of the upper guiding portion 35a with respect to the left-right direction opposes a lower guiding portion 36a of the lower guide 36 described later (overlaps with the lower guiding portion 36a with respect to the left-right direction).

The holding portions 35b and 35b of the upper guide (guiding member) 35 are provided with supporting portion mounting portions 35c and 35c. To the supporting portion mounting portions 35c and 35c of the upper guide (guiding member) 35, a first supporting portion 34 extended in the front-rear direction is mounted. The first supporting portion 34 is constituted by including rollers 34a which are a plurality of rotatable members (rotating members) and a supporting shaft (rotation shaft) 34b rotatably supporting the rollers 34a. Opposite end portions of the supporting shaft 34b with respect to the front-rear direction are mounted to the supporting portion mounting portions 35c and 35c, respectively, of the upper guide 35. Further, in the neighborhoods, close to the right-side end portion of the upper guiding portion 35a with respect to the left-right direction, of opposite end portions of the upper guiding portion 35a with respect to the front-rear direction, second supporting portions 37 and 37 are mounted, respectively. In this embodiment, each of the second supporting portions 37 and 37 is constituted by a pin (in this embodiment, a substantially columnar member) extending toward a lower guiding portion 36a of the lower guide 36 described later, along a direction crossing (in this embodiment, substantially perpendicular to the surface of the upper guiding portion 35a).

The rollers 34a of the first supporting portion 34 contact the print belt 24 positioned on the suction box 26, i.e., the conveying surface 24a of the print belt 24. The first supporting portion 34 presses down the print belt 24 in a position of the rollers 34a by a self-weight of the upper guide 35 and the first supporting portion 34. The first supporting portion 34 is provided integrally with the upper guide 35 by mounting opposite end portions of the supporting shaft 34b with respect to an axial direction to the holding portions 35b and 35b, respectively, of the upper guide 35. The rollers 34a of the first supporting portion 34 are rotated with rotation of the print belt 24 in a state in which the rollers 34a contact the print belt 24. The sheet S passes through between the rollers 34a and the conveying surface 24a of the print belt 24. The rollers 34a have a function of suppressing floating of the sheet S from the conveying surface 24a of the print belt 24 by pressing the sheet S against the conveying surface 24a of the print belt 24. In this embodiment, the upper guiding portion 35a of the upper guide 35 is disposed substantially parallel to the conveying surface 24a of the print belt 24. The second supporting portion 37 contacts an upper surface (surface opposing the upper guiding portion 35a) of the lower guiding portion 36a of the lower guide 36 described later. Thus, the upper guide 35 is supported relative to the conveying surface 24a of the print belt 24 by the first supporting portion 34. In addition, the upper guide 35 is supported relative to the lower guide 36 by the second supporting portion 37. By this, the upper guide 35 is provided to the print belt unit 2200 in a state in which the upper guiding portion 35a is spaced from each of the conveying surface 24a of the print belt 24 and the lower guiding portion 36a of the lower guide 36 by a predetermined distance.

The lower guide 36 includes a flat plate-like lower guiding portion 36a having a predetermined in which with respect to the left-right direction (conveying direction of the sheet S) and extending in the front-rear direction (widthwise direction of the print belt 24). The lower guiding portion 36a is disposed on a surface side (lower side) opposite from the surface (side) where the sheet S is subjected to the recording processing by the recording portion 2300 immediately passing through between the guiding members, (the upper guide 35 and the lower guide 36). In this embodiment, the lower guide 36 is formed of a plate-like member (metal plate) made of metal. In this embodiment, at least a part of an end portion side of a left side (downstream side with respect to the conveying direction of the sheet S) of the lower guiding portion 36a with respect to the left-right direction opposes the print belt 24 (overlaps with the print belt 24 with respect to the left-right direction) in a region where the print belt 24 is wound around the first stretching roller 20.

The lower guide 36 is fixed to an immovable block (not shown) in a position where the lower guide 36 receives the sheet S from an upstream-side unit of the print belt unit 2200 with respect to the conveying direction of the sheet S. This block is mounted to, for example, a belt unit frame (not shown) which is a supporting structure constituting the print belt unit 2200. The lower guide 36 supports the second supporting portion 37 (from below) mounted to the upper guide 35 in the lower guiding portion 36a. By this, a distance K between the upper guiding portion 35a of the upper guide 35 and the lower guiding portion 36a of the lower guide 36 (herein, this distance is also referred to as an "upper guide-lower guide gap (gap between upper guide and lower guide)" K) can be maintained at a substantially constant level.

As shown in FIG. 8, in this embodiment, with respect to the widthwise direction (front-rear direction) of the print belt 24, a width W1 of the upper guiding portion 35a is wider than a width W3 of a region in which the print belt 24 is capable of carrying the sheet S (i.e., a range of the width W3 falls inside a range of the width W1). Further, in this embodiment, with respect to the widthwise direction of the print belt 24, a width W2 of the lower guiding portion 36a is wider than a width W5 of the print belt 24 (i.e., a range of the width W5 falls inside a range of the width W2). Further, in this embodiment, with respect to the widthwise direction of the print belt 24, a width (distance) W4 between the both second supporting portions 37 and 37 is wider than the width W3 of the region in which the print belt 24 is capable of carrying the sheet S (i.e., the range of the width W3 falls inside a range of the width W4). Further, the rollers 34a of the first supporting portion 34 are provided in a plurality of positions substantially equidistantly within the range of the width W1 (distance between both holding portions 35b and 35b) of the upper guiding portion 35a, particularly within the range of the width W3 of the region in which the print belt 24 is capable of carrying the sheet S.

Incidentally, in this embodiment, in an end portion of the upper guide 35 on an upstream side and an end portion of the lower guide 36 on an upstream side with respect to the conveying direction of the sheet S, inclined portions 35d and 36b are provided, respectively, so as to be inclined so that those inclined portions 35d and 36b are spaced from each other toward the upstream side in a manner such that a region in which these inclined portions 35d and 36b are capable of receiving the sheet S is made wide.

The both holding portions 35b and 35b of the upper guide 35 are provided with elongated-shaped guiding holes 35e and 35e, respectively, extending along (in this embodiment substantially parallel to) the up-down direction. Further, guiding shafts (in this embodiment, substantially columnar members) 38 and 38 extending along (in this embodiment, substantially parallel to the front-rear direction) are inserted from an outside (side opposite from sides where the upper guiding portion 35a with respect to the front-rear direction) toward substantially central potions of the guiding holes 35e and 35e with respect to the up-down direction. The guiding shafts 38 and 38 are fixed to immovable shaft supporting portions 61 and 61, respectively. Those shaft supporting portions 61 and 61 are mounted to, for example, the belt unit frame (not shown) which is a supporting structure constituting the print belt unit 2200. A width of each guiding hole 35e and a width of the associated guiding shaft 38 with respect to the left-right direction are substantially the same. By this, a position of the upper guide 35 with respect to the conveying direction of the sheet S is determined by the guiding shafts 38 and 38 and the guiding holes 35e and 35e.

The upper guide 35 is movable so as to be rotated about the second supporting portion 37 (specifically, a contact portion between the second supporting portion 37 and the lower guiding portion 36a) as a rotation center in interrelation with up-down movement of the first supporting portion 34 in a range in which the guiding shafts 38 and 38 are movable in the guiding holes 35e and 35e in the up-down direction. That is, the first supporting portion 34 contacting the conveying surface 24a is raised and lowered by following raising and lowering of the conveying surface 24a of the print belt 24 due to raising and lowering of the suction box 26 (movement of the print belt 24 at the conveying surface 24a in a thickness direction of the print belt 24). At that time, the upper guide 35 is moved so as to be rotated (swung) in an arrow C direction in FIG. 7 about the second supporting portion 37 as a rotation center. Incidentally, in this embodiment, each guiding shaft 38 is substantially reciprocated about the guiding hole 35e in the up-down direction, so that the upper guiding portion 35a is substantially reciprocated in the up-down direction (direction substantially perpendicular to the conveying surface 24a).

By this, depending on the raising/lowering of the suction box 26, the belt-guide gap G which is a distance between the upper guiding portion 35a of the upper guide 35 and the conveying surface 24a of the print belt 24 can be maintained at a substantially constant level.

Each guiding hole 35e has a sufficient space T for permitting upward/downward movement of the suction box 26. The space T is provided in a range of ± 1.5 mm relative to a range of ± 1 mm which is an upward/downward movement distance of the suction box 26 (specifically, the platen member 25). For that reason, the print belt 24 positioned on the suction box 26 is interrelated with the upward/downward movement of the suction box 26 while maintaining a distance between itself and the upper guiding portion 35a (substantially parallel to the conveying surface 24a of the print belt 24) prepared integrally with the first supporting portion 34 at the predetermined distance.

In this embodiment, the belt-guide gap adjusting mechanism 60 is constituted by the guiding shaft 38, the guiding hole 35e, the first supporting portion 34, the second supporting portion 37, the lower guiding portion 36a.

### Printing operation

Next, an example of an operation of each of the print gap adjusting mechanism 50 and the belt-guide gap adjusting mechanism 60 during the printing operation will be described.

In the ink jet recording apparatus 1 (for example, the print module 2000), a storage device 73, such as the ROM or a non-volatile memory, for storing information on the thickness of the sheet S used in a print job. In the storage device 73, for example, the thickness information is stored for each of a plurality of kinds of sheets S. A controller 71 (FIG. 5), such as a CPU, provided in the ink jet recording apparatus 1 (for example, the print module 2000) is capable of acquiring, from the storage device 73, the thickness information of the sheet S used in the printing job, on the basis of information on the kind of the sheet S used in the print job inputted to the ink jet recording apparatus 1 by a user or the like information.

The controller 71 starts the print (job in the case where a setting such that the height of the suction box 26 is capable of providing an apparatus print gap is made. On the other hand, in the case where the setting such that the height of the suction box 26 is capable of providing the appropriate print gap is not made, the controller 71 causes the stepping motor M (FIG. 5) of the print gap adjusting mechanism 50 to be rotated in the step number stored in advance in the ROM (FIG. 5) so as to provide a desired height. As described above, after the stepping motor M is rotated, the cam 29 is not rotated by the one-way clutch 32 (FIG. 5), and therefore, magnetic excitation of the stepping motor M can be switched off. When the height of the suction box 26 is changed, tension exerted on the print belt 24 is changed, and therefore, a change in rotation speed and attitude of the print belt 24 occurs in some instances. In that case, the controller 71 starts the print job after the print belt 24 is rotated by a time required to settle the print belt 24.

In this embodiment, even when the height of the suction box 26 is changed depending on the thickness of the sheet S and correspondingly the height of the conveying surface 24a of the print belt 24 is changed, the belt-guide gap G is maintained at a substantially constant level by the belt-guide gap adjusting mechanism 60. By this, a possibility that conveyance of the sheet S becomes unstable between the print belt 24 and the upper guide 35 is reduced. Further, with respect to the conveying direction of the sheet S, the upper guide 35 is raised and lowered only in an end portion thereof on a first supporting portion 34 side where the upper guide 35 contacts the print belt 24 positioned on the suction box 26, but is not raised and lowered in an end portion thereof on a second supporting portion 37 side. For that reason, even when the position of the lower guide 36 is fixed, the upper guide-lower guide gap K is not changed, and therefore, a possibility that conveyance of the sheet S becomes unstable between the upper guide 35 and the lower guide 36 is reduced.

### Opening operation

In this embodiment, the guiding holes 35e and the guiding shafts 38 are provided so as to guide the raising and lowering of the upper guide 35 with the second supporting portion 37 as a supporting in interrelation with the raising and lowering of the suction box 26.

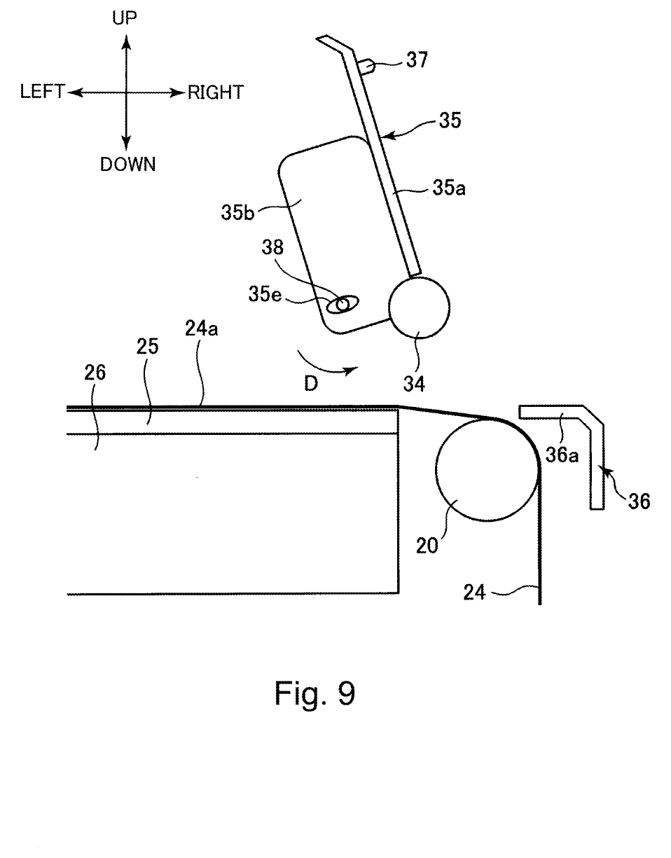

The upper guide 35 constituted as described above is, as shown in FIG. 9, also capable of being rotated on the second supporting portion 37 side in an arrow D direction in FIG. 9 with an engaging portion thereof between the guiding hole 35e and the guiding shaft 38 as a rotation center. When the upper guide 35 is rotated in the arrow D direction in FIG. 9, the rollers 34a of the first supporting portion 34 are operated so as to be spaced from the print belt 24 after traveling on the print belt 24. By this, an operation such as maintenance or the like to a region hidden under the upper guide 35 in a state during the printing operation as shown in FIG. 7 is easily performed. At this maintenance, for example, it is possible to cite jam clearance in the case where jam of the sheet S occurs.

Thus, in this embodiment, the image forming apparatus (ink jet recording apparatus) 1 includes the rotatable endless belt (print belt) 24 for carrying and conveying the sheet S; the recording head 100 for ejecting the liquid for recording to the sheet S conveyed by the belt 24; the platen member 25 disposed on the inner peripheral surface side of the belt 24, for forming the conveying surface 24a on which the sheet S is conveyed by the belt 24 while slidably supporting the belt 24, and movable in the thickness direction of the belt 24 in a state in which the platen member 25 supports the belt 24; the first guiding member (upper guide) 35 which guides the sheet S conveyed toward the conveying surface 24a, which is disposed on the same side as the recording head 100 relative to the sheets conveyed toward the conveying surface 24a, and which is provided so that at least a part of the first guiding member 35 opposes the conveying surface 24a and movable in the direction crossing the conveying surface 24a; the second guiding member (lower guide) 36 which guides the sheet S conveyed toward the conveying surface 24a and which is disposed on a side opposite from the recording head 100 relative to the sheet S conveyed toward the conveying surface 24a; the first supporting portion 34 provided by being connected to the first guiding member 35 and for supporting the first guiding member 35 relative to the conveying surface 24a in contact with the conveying surface 24a; and the second supporting portion 37 provided between the first guiding member 35 and the second guiding member 36 and for supporting the first guiding member 35 relative to the second guiding member 36, wherein the first supporting portion 34 is provided movably together with the first guiding member 35 with movement of the platen member 25. In this embodiment, the first supporting portion 34 includes the rotatable members (rollers) 34a contacting the conveying surface 24a. Further, in this embodiment, the first guiding member 35 is provided rotatably about the second supporting portion 37 as a rotation center. Further, in this embodiment, the image forming apparatus includes the restricting portions (guiding holes 35e, guiding shafts 38) for restricting movement direction of the first guiding member 35 with movement of the platen member 25. Further, in this embodiment, the restricting portions (guiding holes 35e, guiding shafts 38) are provided so as to permit rotation of the first guiding member 35 about the restricting portions as the rotation centers. In this embodiment, each of the restricting portions (guiding holes 35e, guiding shafts 38) is constituted by including the hole provided in the first guiding member 35 and the shaft engaging with the hole. Further, in this embodiment, the second supporting portion 37 is provided by being connected to the first guiding member 35 and supports the first guiding member 35 relative to the second guiding member 36 in contact with the second guiding member 36.

Further, according to this embodiment, even when the conveying surface 24a of the print belt 24 is raised and lowered with the raising and lowering of the platen member 25, the belt-guide gap can be maintained at a substantially constant level with a desired distance. Accordingly, according to this embodiment, it becomes possible to stably perform the conveyance of the sheet S to the conveying surface 24a of the print belt 24.

### Other embodiments

In the above, the present disclosure was described based on specific embodiments, but the present disclosure is not limited to the above-described embodiments.

In the above-described embodiments, the upper guiding portion of the upper guide and the holding portion were formed integrally with each other, but these portions may be constituted by separate members and may also be connected to each other.

Further, in the above-described embodiments, the second supporting portion was mounted to the upper guide, but the present disclosure is not limited thereto. The second supporting portion may only be required to support the first guide by being provided between the first guide and the second guide and may also be mounted to the second guide.

Further, in the distance embodiments, the upper guide was provided with the guiding holes and another fixed member of the print belt unit was provided with the guiding shafts, but a relationship between the member provided with the guiding holes and the member provided with the guiding shafts may also be reverse to the above-described relationship.

Further, the restricting portions for restricting the movement direction of the upper guide by the movement of the platen member are not limited to the constitution including the holes and the shafts engaging with each other, but for example, the restricting portions may also be constituted by projected portion (projections) and a recessed portion (grooves) which engage with each other.

According to the present disclosure, even when the conveying surface of the print belt is raised and lowered with the raising and lowering of the platen member, it becomes possible to stably perform conveyance of the sheet to the conveying surface of the print belt.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-192527, filed on October 31, 2024, which is hereby incorporated by reference herein in its entirety.

What is claimed is:

1. An image forming apparatus comprising:
a rotatable endless belt configured to carry and convey a sheet;
a recording head provided opposed to the belt and configured to eject a liquid for recording to the sheet conveyed by the belt;
a platen member provided in a position opposing the recording head through the belt and configured to support an inner peripheral surface of the belt and to form a conveying surface on which the sheet is conveyed, the platen member being supported movably in a thickness direction of the belt;
a first guiding member provided movably in a direction crossing the conveying surface and configured to guide a first surface, of the sheet conveyed toward the conveying surface, opposing the recording head;
a second guiding member configured to guide a second surface of the sheet conveyed toward the conveying surface;
a first supporting portion provided movably and integrally with the first guiding member and configured to support the first guiding member in contact with the conveying surface; and
a second supporting portion provided between the first guiding member and the second guiding member and configured to support the first guiding member relative to the second guiding member.

2. The image forming apparatus according to claim 1, wherein the first supporting portion includes a rotatable member contacting the conveying surface.

3. The image forming apparatus according to claim 1, wherein the first guiding member is provided rotatably about the second supporting portion as a rotation center.

4. The image forming apparatus according to claim 1, further comprising a restricting portion configured to restrict a movement direction of the first guiding member with movement of the platen member.

5. The image forming apparatus according to claim 4, wherein the restricting portion is provided so as to permit rotation of the first guiding member about the restricting portion as a rotation center.

6. The image forming apparatus according to claim 4, wherein the restricting portion is constituted by including a hole provided in the first guiding member and a shaft engaging with the hole.

7. The image forming apparatus according to claim 1, wherein the second supporting portion is provided on the first guiding member and regulates a distance between the first guiding member and the second guiding member in contact with the second guiding member.
